(19) United States
(12) Patent Application Publication
(10) Pub. No.: US 2020/0037796 A1
(43) Pub. Date: Feb. 6, 2020

(54) PILLOW

(71) Applicant: REISSI HOLDINGS PTY LTD, Bondi Junction, NSW (AU)

(72) Inventor: Mark Reissi, Bondi Junction, NSW (AU)

(73) Assignee: REISSI HOLDINGS PTY LTD, Bondi Junction, NSW (AU)

(21) Appl. No.: 16/485,431

(22) PCT Filed: Feb. 13, 2018
(86) PCT No.: PCT/AU2018/050112

§ 371 Date: Aug. 12, 2019

(30) Foreign Application Priority Data
Feb. 13, 2017 (AU) AU2017900448

(51) Int. Cl. A47G 9/10

(52) U.S. Cl. CPC A47G 9/10; A47G 2009/1018

(57) ABSTRACT

In a first aspect there is disclosed a pillow (10) which including an envelope (12) enclosing pillow stuffing (14), wherein the pillow stuffing includes a plurality of elongate bodies (40). In one embodiment the elongate bodies are produced from memory foam.

### FIELD

The present invention relates to a pillow, in particular but not exclusively, a pillow for supporting the head and neck of a person sleeping.

### BACKGROUND

A pillow is typically employed to support the head and neck of a person while sleeping. Conventional pillows include an outer envelope which contains soft stuffing to support the weight of a user's head and neck. Such stuffing could take a range of forms including down feathers, synthetic fibres and latex. Down feather pillows tend to be the most comfortable pillows, but are also the most expensive. They offer the advantage of softness and the ability to conform to supportive shapes desired by a user. Down pillows, however, suffer from the drawback of causing allergic reactions in many users.

The best type of pillows are able to maintain the spine of a user in a neutral stress-free alignment. The preferred pillow for a particular user should be suitable for the user's favoured sleeping position and adequately support the head and neck of the user. Further, a pillow should be comfortable to lie on and be durable so as to ensure a good night's rest over a relative long term of use.

Research indicates that a person will tend to sleep best in their favourite sleeping position, for example on the user's stomach/back or in the foetal position. Accordingly, once a person's preferred sleeping posture has been identified a pillow must be identified which best matches the sleeping posture as not all pillows are suited to all sleeping postures.

### OBJECT

It is an object of the present invention to provide an alternative pillow able to support a range of users having different favoured sleeping positions.

### SUMMARY

In a first aspect there is disclosed herein a pillow including an envelope enclosing pillow stuffing, wherein the pillow stuffing includes a plurality of elongate bodies.

Preferably the elongate bodies are of cylindrical shape.

Preferably the elongate bodies include foam.

Preferably the foam is memory foam.

Preferably the memory foam include polyurethane.

Preferably the elongate bodies include latex.

Preferably the elongate bodes have a length of between 10 to 12 cm and a diameter of about 1 cm.

Preferably the envelope includes wood-based cellulose fibre.

Preferably the wood-based cellulose fibre is pine wood cellulose fibre.

Preferably the wood-based cellulose fibre is wood-based cellulose viscose fibre.

Preferably the wood-based cellulose fibre is fibre sold under the trade mark Lenpur®.

Preferably the envelope includes an outer cover and an inner cover.

Preferably the outer cover includes opposing first and second outer face panels and an outer side panel operatively located between the first and second outer face panels, the outer face panels and the outer side panel defining an enclosure.

Preferably the outer cover includes an outer fastener, the outer fastener adapted to provide access to the enclosure.

Preferably each outer face panel includes wood-based cellulose fibre.

Preferably each outer face panel includes pine wood cellulose fibre.

Preferably each outer face panel includes wood-based cellulose viscose fibre.

Preferably each outer face panel includes fibre sold under the trade mark Lenpur®.

Preferably the outer side panel is produced from a breathable material.

Preferably the breathable material includes an acrylic textile fibre.

Preferably the inner cover includes opposing first and second inner face panels and an inner side panel operatively located between the first and second inner face panels, the inner face panels and the outer side panel defining a stuffing enclosure, the inner cover sized for location within the enclosure of the outer cover.

Preferably the inner cover includes an inner fastener adapted to provide access to the stuffing enclosure.

Preferably each inner face panel includes cotton.

Preferably the inner side panel is produced from a breathable material.

Preferably the breathable material includes an acrylic textile fibre.

Preferably the elongate bodies of the pillow stuffing are held within the stuffing enclosure.

### BRIEF DESCRIPTION OF THE DRAWINGS

A preferred embodiment of the invention will be described hereinafter, by way of an example only, with reference to the accompanying drawings wherein:

FIG. 1 is a schematic sectional representation of various components of an embodiment pillow;

FIG. 2 is a schematic representation of an outer cover of the pillow of FIG. 1;

FIG. 3 is a schematic representation of an inner cover of the pillow of FIG. 1; and

FIG. 4 is a schematic representation of an elongate body forming part of stuffing of the pillow of FIG. 1.

### DESCRIPTION OF PREFERRED EMBODIMENT

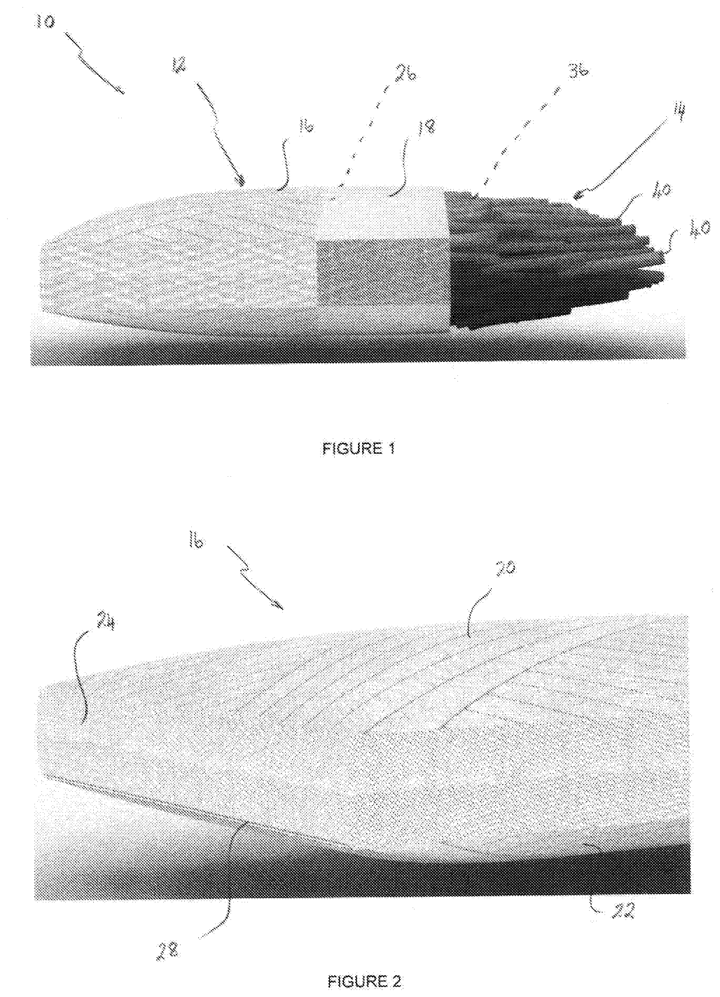

FIG. 1 shows a first embodiment pillow, generally indicated with the reference numeral 10. The pillow 10 includes an envelope 12 enclosing pillow stuffing 14. The embodiment stuffing is produced from a synthetic material. The envelope 12, in turn, includes an outer cover 16 and an inner cover 18.

Referring also to FIG. 2, the outer cover 16 includes opposing first and second outer face panels 20, 22 and an outer side panel 24 operatively located between the first and second outer face panels 20, 22. The outer face panels 20, 22 and the outer side panel 24 define an enclosure 26. The outer cover includes an outer fastener 28, here a zip fastener, which can be opened to provide access to the enclosure 26.

The outer face panels 20, 22 include a pine wood-based cellulose viscose fibre. In this embodiment the wood-based fibre is of the type sold under the trade mark Lenpur®. The outer side panel 24 is produced from a breathable material, in this embodiment an acrylic textile fibre.

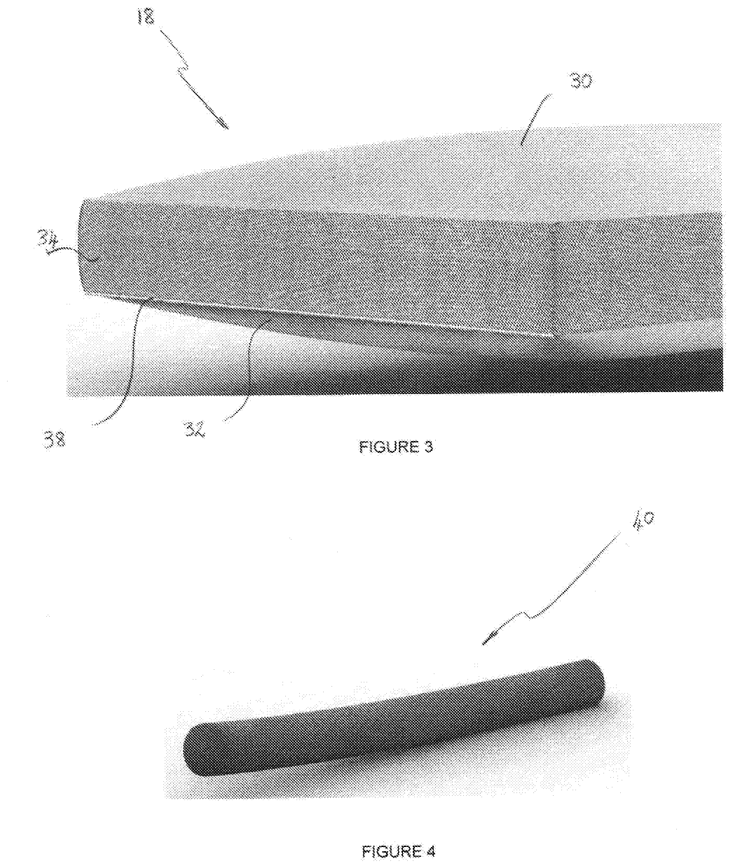

Referring also to FIG. 3, the inner cover 18 includes opposing first and second inner face panels 30, 32 and an inner side panel 34 operatively located between the first and second inner face panels 30, 32. The inner face panels 30, 32 and the outer side panel 34 define a stuffing enclosure 36. The inner cover 18 is sized for location within the enclosure 26 of the outer cover 16.

The inner cover 18 includes an inner fastener 38, again in the form of a zip fastener, adapted to be opened to provide access to the stuffing enclosure 36.

The embodiment inner face panels 30, 32 include cotton. As with the outer side panel 24, the inner side panel 34 is also produced from a breathable material, namely an acrylic textile fibre.

The pillow stuffing 14 is held within the stuffing enclosure 36. In this embodiment the pillow stuffing 14 includes memory foam in the form of a polyurethane. It will be understood that the pillow stuffing 14 can take other forms, such as latex.

The pillow stuffing 14 includes a plurality of independent elongate, longitudinally extending bodies 40, one of which is illustrated in FIG. 4. The elongate bodies 40 (or micro-loops) are of general cylindrical/tubular shape and have a length of between 10 to 12 cm and a diameter of about 1 cm. The elongate bodies 40 are movable relative to one another so as to permit the pillow 10 to be shaped as required by a user. The amount of pillow stuffing can be increased or decreased by adding or removing elongate bodies 40. This enables the pillow 10 to be configured to accommodate different sleeping postures. Furthermore, by employing memory foam for producing the pillow stuffing 14, the pillow 10 is responsive. What this means is that the memory foam is adapted to sustain the weight of a user's head and neck progressively, allowing unrestricted and ease of movement for optimal circulation throughout a user's slumber. After use the memory foam will return the pillow 10 to its original shape.

A preferred feature of the Lenpur® outer cover 16 and breathable side panels 24, 34 allows for air circulation. Such air circulation will ensure the outer cover 16 in contact with the body of a user is maintained at a temperature which is pleasant.

The materials employed in constructing the envelope 12 is of organic material and this has the benefit of being recyclable.

The outer cover 16 is typically treated with anti-pilling finish as well as an anti-bacterial substance. The outer cover 16 further can be removed and the materials from which it is produced enables machine washing.

Although the invention is described above in relation to preferred embodiments, it will be appreciated by those skilled in the art that it is not limited to those embodiments, but may be embodied in many other forms.

1. A pillow including an envelope enclosing pillow stuffing, wherein the pillow stuffing includes a plurality of elongate bodies.

2. A pillow according to claim 1, wherein the elongate bodies include foam.

3. A pillow according to claim 2, wherein the foam is memory foam.

4. A pillow according to claim 3, wherein the memory foam is polyurethane.

5. A pillow according to claim 1, wherein the elongate bodies include latex.

6. A pillow according to claim 1, wherein the elongate bodies are of cylindrical shape.

7. A pillow according to claim 6, wherein the elongate bodies have a length of between 10 to 12 cm and a diameter of about 1 cm.

8. A pillow according to claim 1, wherein the envelope includes wood-based cellulose fibre.

9. A pillow according to claim 8, wherein the wood-based cellulose fibre is pine wood cellulose fibre.

10. A pillow according to claim 8, wherein the wood-based fibre is wood-based cellulose viscose fibre. cellulose

11. A pillow according to claim 1, wherein the envelope includes an outer cover and an inner cover.

12. A pillow according to claim 11, wherein the outer cover includes opposing first and second outer face panels and an outer side panel operatively located between the first and second outer face panels, the outer face panels and the outer side panel defining an enclosure.

13. A pillow according to claim 12, wherein the outer cover includes an outer fastener, the outer fastener adapted to provide access to the enclosure.

14. A pillow according to claim 13, wherein each outer face panel includes wood-based cellulose fibre.

15. A pillow according to claim 14, wherein each outer face panel includes pine wood cellulose fibre.

16. A pillow according to claim 15, wherein each outer face panel includes wood-based cellulose viscose fibre.

17. A pillow according to claim 12, wherein the outer side panel is produced from a breathable material.

18. A pillow according to claim 17, wherein the breathable material is an acrylic textile fibre.

19. A pillow according to claim 11, wherein the inner cover includes opposing first and second inner face panels and an inner side panel operatively located between the first and second inner face panels, the inner face panels and the outer side panel defining a stuffing enclosure, the inner cover sized for location within the enclosure of the outer cover.

20. A pillow according to claim 19, wherein each inner face panel includes cotton.

21-22. (canceled)
